(19) United States
(12) Patent Application Publication
(10) Pub. No.: US 2013/0250070 A1
(43) Pub. Date: Sep. 26, 2013

(54) IMAGE SYNTHESIS DEVICE

(71) Applicant: Jun Takayama, Tama-shi (JP)

(72) Inventor: Jun Takayama, Tama-shi (JP)

(73) Assignee: KONICA MINOLTA, INC., Tokyo (JP)

(21) Appl. No.: 13/990,808

(22) PCT Filed: Nov. 18, 2011
(86) PCT No.: PCT/JP2011/076669

§ 371 Date: May 31, 2013

(30) Foreign Application Priority Data
Dec. 1, 2010 (JP) 2010268170

(51) Int. Cl. H04N 13/02

(52) U.S. Cl. CPC H04N 13/0239
USPC 348/47

(57) ABSTRACT

An image synthesis device capable of imaging an object regardless of the luminance of the object, and capable of suppressing the misalignment of the objects in the synthesized linage, is disclosed, A viewpoint conversion unit performs viewpoint conversion regarding a visible light image, and thus, a viewpoint of a far-infrared light image matches a viewpoint of a visible light image. Therefore, when image signals of the images are superposed in a superimposition unit, the misalignment of the objects having different object distances is suppressed in the synthesized image, and the synthesized image does not appear strange for a person viewing the synthesized image.

### TECHNICAL FIELD

The present invention relates to an image synthesis device for acquiring object information to form an object image, particularly, the image synthesis device capable of forming an appropriate object image even at night.

### BACKGROUND ART

In recent years, both, the number of car accidents and a casualty toll are decreasing, but they are still held in a high level. Moreover, since aged, drivers are expected to increase in the future, there have been demanded greater techniques of compensating for the decline of a body function due to aging and supporting safe driving. Particularly, there have recently been developed pre-crash safety techniques of preventing accidents due to the decline of driver's concentration ability or human errors by detecting and recognizing obstacles such as persons or cars in front of an advancing direction in order to ensure safe running of a car, and some of these techniques are sold commercially,

By the way, as means for recognizing a forward obstacle, there are generally used a radar device using an electromagnetic wave or laser, a camera device using visible light or infrared light and so on, but any of these systems has both advantages and disadvantages; therefore it is desirable to use while combing it with another system to improve reliability. For example, supposing the combination of a visible light camera with a far-infrared camera, since an object light amount is sufficient during the daytime, it is possible to recognize the obstacle by using the visible light camera, whereas as for a far object to which headlight does not reach at night, it is difficult to photograph the object using the visible light camera. So, in such a case, the use of the visible light camera in combination of the far-infrared light camera makes it possible to quickly recognize a person or the like located beyond irradiation range of the headlight even if it is not visible to the naked eye.

Nevertheless, in the case of causing a driver to know an image photographed by both the visible light camera and the far-infrared light camera, or information concerning an obstacle obtained from the photographed image, it is desirable to display these pieces of image information in a lump in order to raise visibility. However, for example, the visible light camera and the far-infrared light camera are different from each, other in wavelength regions of electromagnetic waves to be detected, nevertheless, an optical material to suitable transmit both visible light and far-infrared light does not substantially exist; therefore it is inherently impossible to coincide the optical axes of the visible light camera and the far-infrared light camera with each other. In short, a visible light image photographed by the visible light camera and a far-infrared light image photographed by the far-infrared light camera are different in viewpoint position from each other. If such images different in viewpoint position are merely overlapped, there is the problem in which the positions of the obstacle are misaligned depending on different object distances, and the visibility of displayed image deteriorates. By contrast, Patent Document 1 discloses a technique for performing a process so that the same objects are superposed on each other by extracting objects using an image recognition process when synthesizing a visible light image and a far-infrared light image.

### PRIOR ART DOCUMENT

### Patent Document

Patent Document 1: Japanese Patent Application Publication No. 2008-233398

### SUMMARY OF INVENTION

### Problems to be Solved by the Invention

However in the technique of the Patent Document 1, it is necessary to image the same object using both the visible light camera and the far-infrared light camera to coincide the positions of their objects with each other, but there is the problem in which many of the objects are photographed in only either one of the visible light image and the far-infrared light image; thus, it is not necessarily possible to align the objects. Moreover, it is possible to coincide the objects photographed by both the visible light camera and the far-infrared light camera with each other, but since the image of an object locating at a distance near or far from a target object is synthesized in deviation, there is also a risk that a person viewing the synthesized image may feel strange.

In view of the aforementioned problems, it is an objective of the present invention to provide an image synthesis device which can photograph an object regardless of a luminance of the object and can suppress the misalignment of the objects in the synthesized image.

### Solution to Problems

An image synthesis device in the present invention is characterized by comprising:
first image acquisition means for acquiring object information using an electromagnetic wave in a first wavelength region to generate first image information concerning an object;
second image acquisition means for acquiring object information using an electromagnetic wave in a second wavelength region from a viewpoint different from that of the first image acquisition means to generate second image information concerning the object; the second wavelength region being different from the first wavelength region;
distance measurement means for obtaining distance information to the object;
three-dimensional information generation means for generating three-dimensional information of the object on the basis of the distance information to the object; and
viewpoint conversion means for processing image information related to at least one of a first image and a second image on the basis of the generated three-dimensional information of the object so that photograph viewpoints in the first image based on the first image information and in the second image based on the second image information coincide with each other.

According to the present invention, the viewpoint conversion means processes image information, related to at least one of the images on the basis of the generated three-dimensional information of the object so that imaging viewpoints in the first image based on the first image information and in the second image based on the second image information coincide with each other, and hence, the superimposition means superimposes the first image information and the second image information on each other so that the first image and second image with their viewpoints having been converted are superposed, whereby it is possible to obtain a synthesized image in which the object misalignment is suppressed regardless of the distance to the object. Incidentally, the electromagnetic wave in the first wavelength region refers to, for example, visible light having a wavelength in a range from 400 nm to 700 nm. Also, the electromagnetic wave in the second wavelength region refers to, for example, far-infra red light, a terahertz wave, a mill wave, a microwave or the like, having a wavelength of 4 μm or more. Furthermore, the “image information” refers to, for example, an image signal. Moreover, the terra “superpose” conceptually includes combining parts of images with each other in a state of fixing relative positions on an image plane.

Furthermore, one embodiment of the present invention is characterized by comprising superimposition means for superimposing the first image information and the second image information on each other so as to superpose the first image and second image which have been subjected to a viewpoint conversion process by the viewpoint conversion means. This makes it possible to synthesize an image free from, the misalignment,

Furthermore, one embodiment of the present, invention is characterized by comprising superimposition means for extracting specific pieces of information from the first image and second image which have been subjected to the viewpoint conversion process by the viewpoint conversion means to superimpose the extracted specific pieces of information on each other.

Furthermore, as one embodiment of the present invention, it is preferable for the superimposition means to extract object information having a luminance value equal to or larger than a predetermined value in the second image information to insert the extracted object information to the first image information. For example, in the case where the electromagnetic wave in the second wavelength region is far-infrared light, when the far-infrared light equal to or larger than the predetermined value is detected, the object is judged to be a human body, therefore, displaying the image with such information being inserted to the first image information makes it possible to give early warning to a person viewing the image.

Furthermore, as one embodiment of the present invention, it is preferable for the superimposition means to extract object information having a specific color or shape from the first image information to insert the extracted object information to the second image information. For example, in the case where the electromagnetic wave in the first wavelength region is visible light, storing in advance colors or shape of a traffic light signal makes it possible to extract the traffic light signal from the visible light image through image recognition, and displaying the image with such information being inserted to the second image information makes it possible to give early warning to a person viewing the image.

Furthermore, as one embodiment of the present invention, it is preferable for the superimposition means to extract, object information having a specific color or shape from the first image information and extract object information having a luminance value equal to or larger than a predetermined value in the second image information to insert the extracted object information in another background image information. For example, in the case where the electromagnetic wave in the first wavelength region is visible light, storing in advance colors or shape of a traffic light signal makes it possible to extract the traffic light signal from the visible light image through image recognition. In the case where the electromagnetic wave in the second wavelength region is far-infrared light, when the far-infrared light equal to or larger than the predetermined value is detected, the object is judged to be a human body, therefore, extracting these information to insert to another background makes it possible to give early warning to a person viewing the image.

Furthermore, as one embodiment of the present invention, it is preferable to add predetermined information to the extracted object information. Herein, the “predetermined information” may be information of a frame surrounding the object, and it is also possible to represent a distance to the object, for example, by a numeral value.

Furthermore, as one embodiment of the present invention, it is preferable that the distance measurement means acquires the distance information to the object on the basis of a plurality of parallax information obtained from the first image acquisition means or the second image acquisition means and that the three-dimensional information generation means acquires the three-dimensional, information, of the object by applying the distance measurement information to the whole of an image plane.

Furthermore, as one embodiment of the present invention, it is preferable that the distance measurement means measures a distance to the object by projecting an electromagnetic wave to the object and measuring arrival time or a direction of a reflected electromagnetic wave and that the three-dimensional information generation means acquires the three-dimensional information of the object on the basis of the distance to the object.

Furthermore, as one embodiment of the present invention, it is preferable that the electromagnetic wave in the first wavelength region is visible light or near-infrared light, or the visible light and near-infrared light, and the electromagnetic wave in the second wavelength region is far-infrared light.

### Effects of Invention

According to the present invention, it is possible to synthesize using a minimum structure, for example, images of visible light and far-infrared light to an image viewing from one viewpoint and to align the position of even the object photographed by only one of cameras.

### BRIEF DESCRIPTION OF DRAWINGS

FIG. 1 is a schematic diagram of a vehicle on which an image synthesis device according to a first Embodiment is mounted.

FIG. 2 is a block diagram of the image synthesis device according to the first Embodiment,

FIG. 3 is a diagram showing a state of measuring a distance to an object by a stereo camera.

FIG. 4 consists of a diagram (a) showing an image (a far-infrared light image) obtained by photographing a scene in the evening by a far-infrared light camera 3 in the first Embodiment, and a diagram (b) showing an image (a visible light image) obtained by photographing the same object at the same timing by a visible light camera 1.

FIG. 5 is a schematic diagram showing processes in an image synthesis unit 10 shown in FIG. 2, (a) represents a pair of images inputted from visible light cameras 1 and 2, (b) represents a distance image, (c) represents a viewpoint converted distance image, and (d) represents an image of viewpoint converted two-dimensional image data.

FIG. 6 is a diagram showing a far-infrared light image (a) and a visible light image (b) which coincide in viewpoint with each other.

FIG. 7 is a diagram showing an example of a synthesized image obtained by superposing a visible light image on a far-infrared light image.

FIG. 8 is a diagram showing an example of a synthesized image obtained, by superposing a far-infrared light, image on a visible light image.

FIG. 9 is a diagram showing an example of a synthesized image obtained by superposing only an extract from a visible light image and an extract from a far-infrared light image on each other,

FIG. 10 is a diagram showing a synthesized image obtained by superposing a far-infrared light image on a visible light image and further adding a box to each object.

FIG. 11 is a block diagram of an image synthesis device according a second Embodiment,

### EMBODIMENTS FOR CARRYING OUT THE INVENTION

### First Embodiment

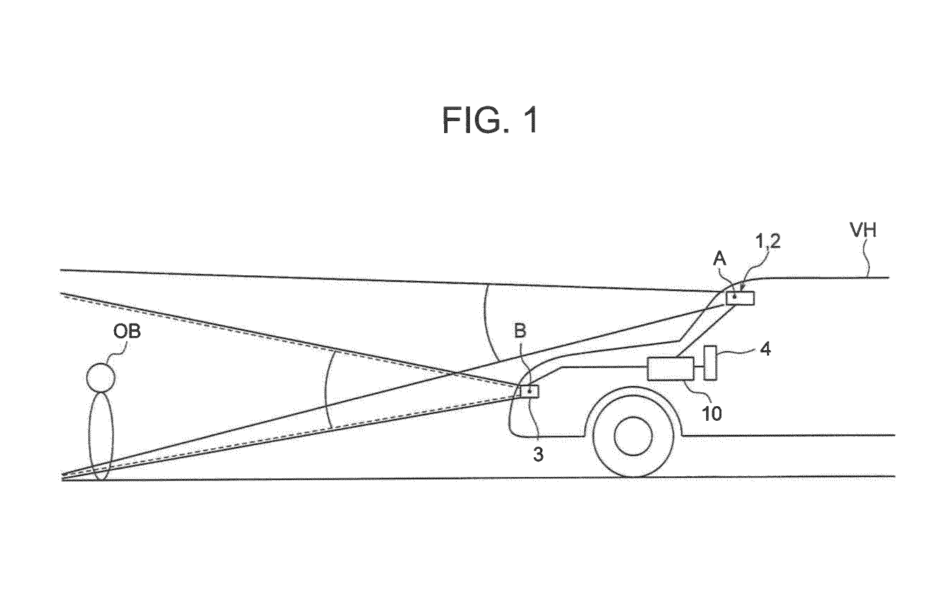

An image synthesis device according to Embodiments of the present invention is explained hereinafter, FIG. 1 is a schematic diagram of a vehicle on which an image synthesis device according to a first Embodiment is mounted. In FIG. 1, visible light cameras 1 and 2 are attached inside a front glass of a vehicle VH, and a far-infrared light camera is attached near a front grille of the vehicle VH. The visible light cameras 1 and 2 as first image acquisition means and distance measurement means receive visible light from an object OB at a vertical direction viewpoint position A to output the received light as an image signal, and a far-infrared light camera 3 as the second image acquisition means receives far-infrared light at a vertical direction viewpoint position B to output the received light as an image signal. However, herein, it is assumed that a viewpoint of the visible light camera 1 exists above in a vertical direction of a viewpoint of the far-infrared light camera 3, seen from the front. Image signals from the cameras 1 to 3 are inputted to an image syntheses section 10, and an image signal processed in the image syntheses unit is outputted to a display device 4 as a monitor so as to display a synthesized image visible by a driver of the vehicle VH. The image synthesis device comprises the cameras 1 to 3 and the image synthesis unit 10.

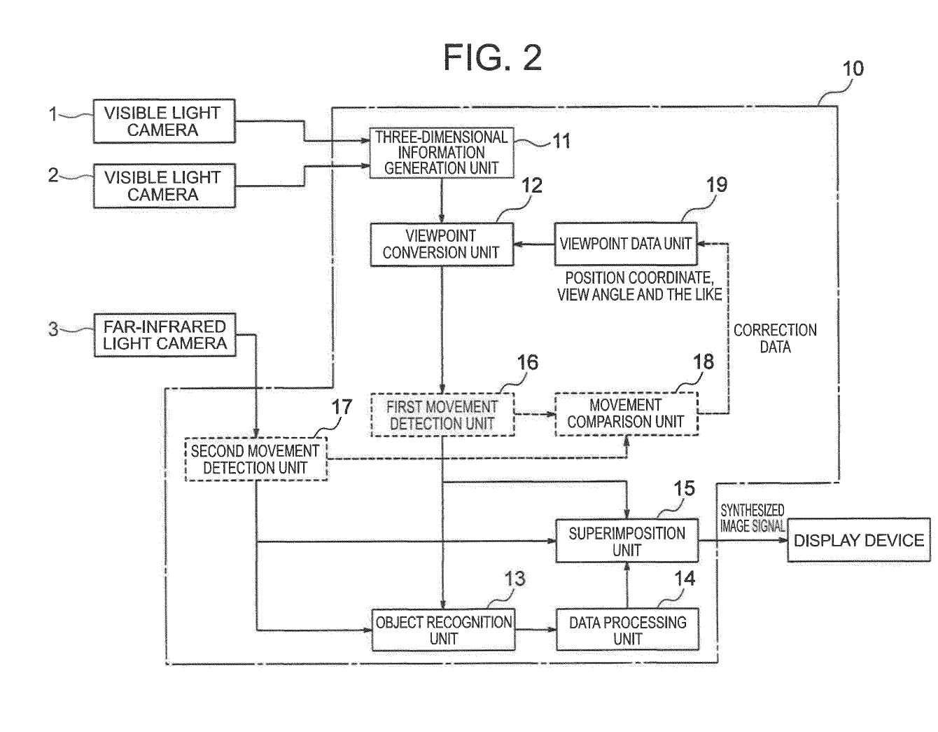

FIG. 2 is a block diagram of the image synthesis device according to the first Embodiment. In FIG. 2, the image synthesis section 1.0 includes a three-dimensional information generation unit 11 as the three-dimensional information generation means, a viewpoint conversion unit 12 as the viewpoint conversion means, an object recognition unit 13, a data processing unit 4, a superimposition unit 15 as the superimposition means, and a viewpoint data unit 19. In addition, besides these components, a first movement detection unit 16, a second movement detection unit 17, and a movement comparison unit 18 may be included.

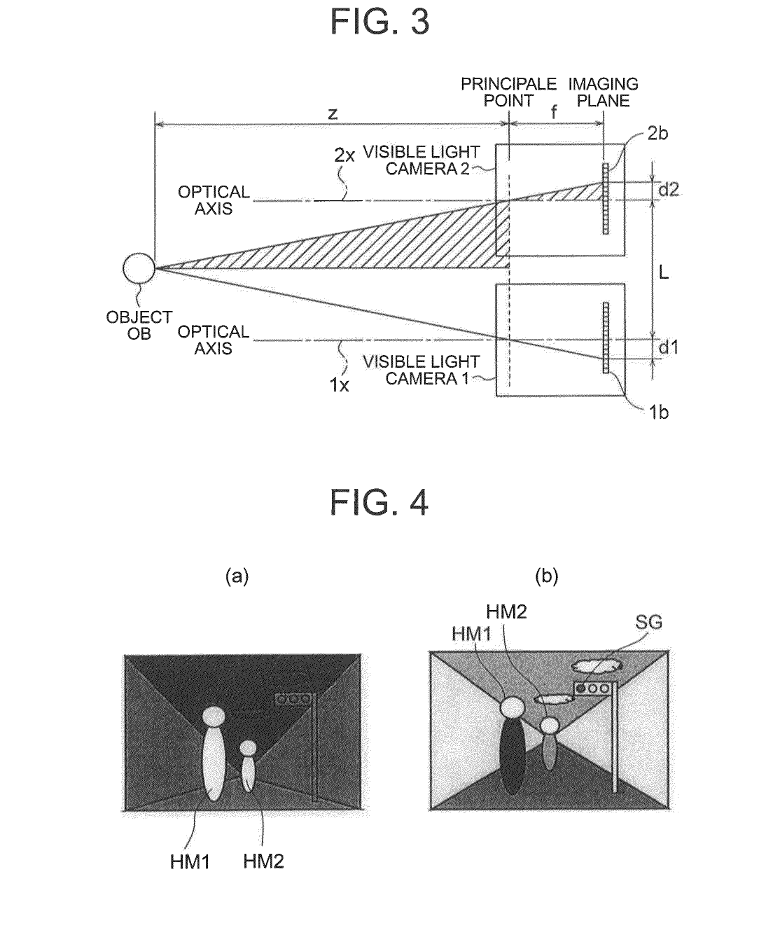

The three-dimensional information generation unit 11 extracts three-dimensional information via a principle of stereo camera on the basis of image signals of the visible light cameras 1 and 2. FIG. 3 is a diagram showing a. state of measuring a distance to an object by a stereo camera. In FIG. 3, the visible light cameras 1 and 2 equipped with a pair of imaging elements are arranged so that they are separated by a predetermined base line distance L and their optical axes become parallel to each other. For images of an object photographed by the visible light cameras 1 and 2, correspondence detection is performed in a unit of pixel, for example, using an SAD (Sum of Absolute Difference) process as a correspondence detection technique, parallax for the object in a lateral direction between the visible light cameras 1 and 2 is determined, and a distance to the object can be determined, based on the determined parallax, on the basis of the following formula.

In FIG. 3, there are used two cameras 1 and 2 which are equal to each other in at least a focal length (f), the number of pixels of an imaging device (CCD), and a size (μ) of one pixel, and these cameras are separated by a predetermined base line length (L) in a lateral direction, and their optical axes 1× and 2× are arranged in parallel to photograph an object OB. Herein, in the example of FIG. 3(a), if it is assumed that a pixel number (which is to be counted from, the left end or right end) of an end part of the object OB on an imaging plane 1b in the camera 1 is x1, a pixel number of an end part of the same object OB on an imaging plane 2b in the camera 2 is x2 (assuming that y is the same), parallax (the number of misalignment pixels) on the imaging planes 1b and 2b is d(=x1-x2), and two triangles shown by giving oblique lines are similar to each other. Accordingly, a distance (Z) to the object OB satisfies the following relationship:

Z:f=L: μ×d=L: (d1+d2),

which leads to the following formulas

Z=(L×f)/(d1+d2) (1),

The view point conversion unit 12 performs image processing so as to change a viewpoint position with respect to the image signals of the visible light, cameras 1 and 2 by calculating a viewpoint coordinate or a view angle on the basis of the three-dimensional information obtained by the three-dimensional information generation unit 11. At this time, if the view angle is different, it is also possible to match the view angle. As for the viewpoint conversion, there is description, for example, in Japanese Patent Application Publication No. 2008-099136. Moreover, when converting the viewpoint position, it is preferable to convert the viewpoint position by referring to the relative position data of the preset visible light camera 1 and far-infrared light c which is stored in the viewpoint data unit 19. The synthesis of a visible light image and a far-infrared light image, which have been converted in viewpoint, generates a visible light/far-infrared light synthesized image seen from the position of the far-infrared light camera, In addition, the viewpoint position of the visible light image may be matched with the viewpoint position of the far-infrared light image, and vice versa.

The object recognition unit 13 has a function of discriminating and extracting a type of the object, for example, from a far-infrared value or a color and a shape of the object. The data processing unit 14 has a function of forming a frame or the like for an image of the object extracted by the object recognition unit 13. The superimposition unit 15 has a function of superposing images with viewpoints being matched. A synthesized image signal based on the superposed images is outputted to the display device 4 to display the synthesized image.

In the case of having the first movement detection unit 16, the second movement detection unit 17 and the movement, comparison unit 18, the first movement detection unit 16 detects movement of the object photographed by the visible light cameras 1 and 2, the second movement detection unit 17 detects movement of the object photographed by the far-infrared light camera 3, and both movements can compared to each other in the movement comparison unit 18. When it is recognized, that the same object, is imaged in the visible light cameras 1 and 2 and in the far-infrared light camera 3, it is possible to carry oat correction for alignment using the movement of the captured image. In short, the movement comparison unit 18 recognizes respective regions in the images of the visible light cameras 1 and 2 and the image of the far-infrared light camera 3f where the same object is imaged, the unit 18 measures a misalignment amount in position between these regions. If the misalignment, amount is equal, to or more than a reference value, position data for viewpoint change stored in the view data unit 19 is corrected. Periodic correction allows errors due to a temporal change to be corrected. This makes it possible to obtain a synthesized image not appear strange by matching the viewpoint even for a moving object.

Next, an operation in this embodiment is explained giving concrete examples. FIG. 4(a) shows an image (a far-infrared light image) obtained by photographing a scene in the evening using the far-infrared light camera 3, and in this image objects HM1 and HM2 as persons generating heat are photographed shining brightly, but a road or wall surface, an LED traffic light, signal generating less heat (which has recently increased) and so on are not clearly photographed. On the other hand, FIG. 4(b) shows an image (a visible light image) obtained by photographing the same object at the same timing using the visible light camera 1. Since this image is in the evening, an object luminance is low as a whole, and the persons HM1 and HM2 are not clearly photographed although the lamp of the traffic light signal SG voluntarily emitting light is clearly photographed. Herein, since the viewpoint position of the far-infrared light camera 3 and the viewpoint position of the visible light camera 1 are separated from each other in a vertical direction, the viewpoints of two images are different, from each other, as being clear from FIG. 4. Hence, if both images are overlapped as they are, imaged objects are misaligned from each other.

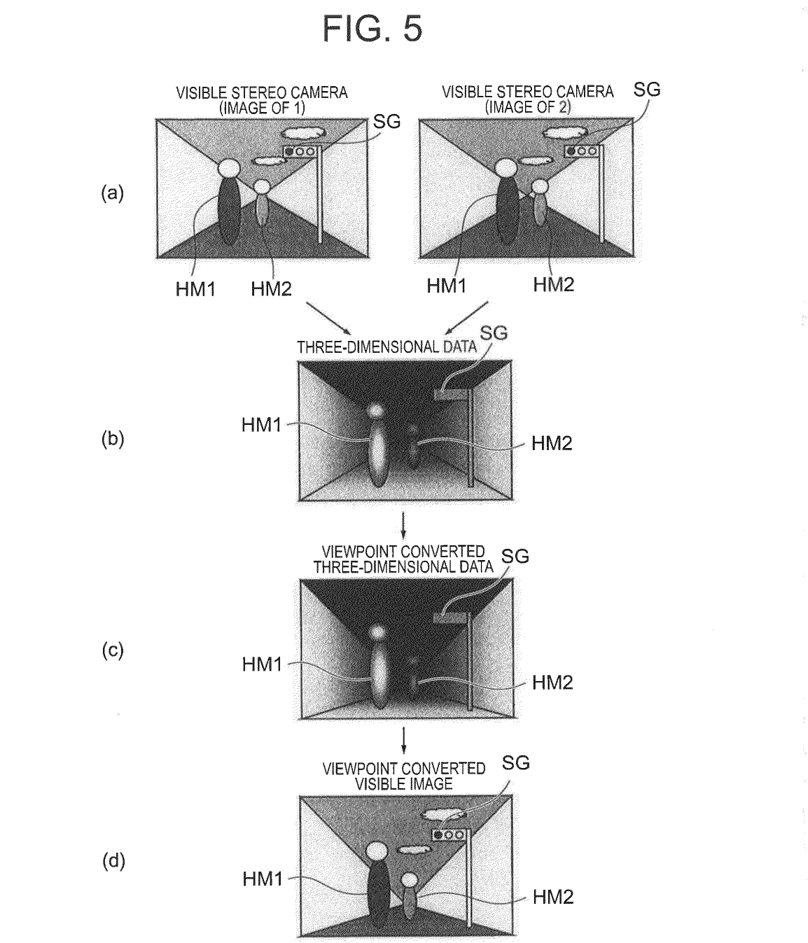

FIG. 5 is a schematic diagram showing processes in the image synthesis section 10. First, the three-dimensional information generation unit 11 inputs image signals from the visible light, cameras 1 and 2. A pair of images obtained by these image signals is shown in FIG. 5(a). Furthermore, the three-dimensional information generation unit 11 generates three-dimensional data using a principle as shown in FIG. 3. Thus obtained distance image is shown in FIG. 5(b). After that, the viewpoint conversion, unit 12 performs viewpoint conversion utilizing the generated three-dimensional data. The distance image subjected to the viewpoint, conversion is shown in FIG. 5(c). That is, the distance information to the object is acquired on the basis of the parallax information obtained from the visible light cameras 1 and 2, and the application of such distance measurement information to an entire screen makes it possible to acquire the three-dimensional information of the object. Since a distance, which the object should move depending on a distance, is seen from the distance image in FIG. 5(b) and the distance image in FIG. 5(c), this is utilized to determine two-dimensional image data with its viewpoint, having been converted, by misaligning the object position in the two-dimensional image data. An image for such two-dimensional image data is shown in FIG. 5(d).

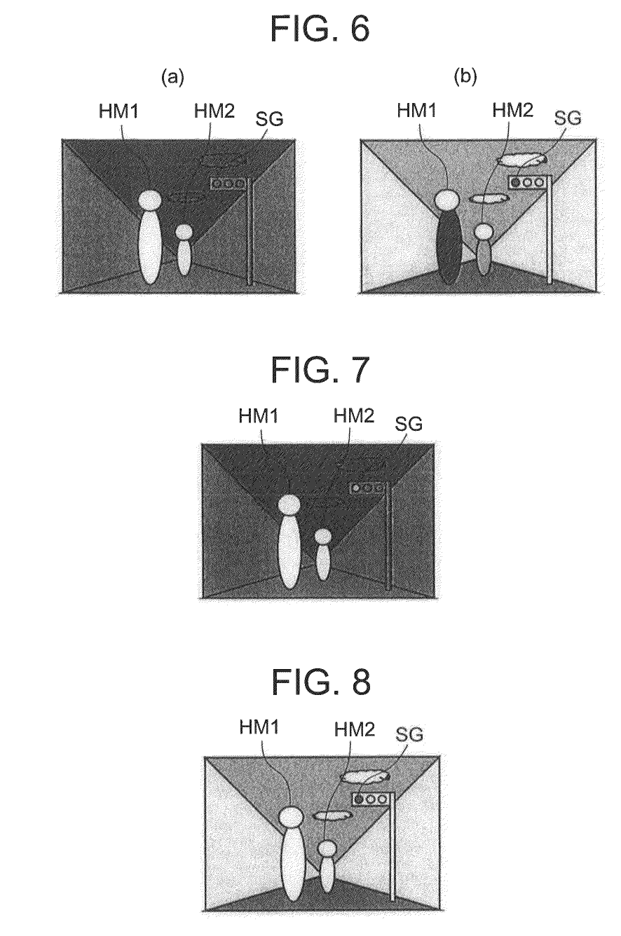

Since the viewpoint conversion for the visible light image is performed in the aforementioned way, as shown in FIG. 6, the viewpoint of the far-infrared light image (a) and the viewpoint of the visible light image (b) result in coinciding with each other. Hence, in the case of superposing both images in the superimposition unit 15, the misalignment of the objects having different object distances in a synthesized image is suppressed, and the synthesized image does not appear strange for a person viewing the synthesized image.

FIG. 7 is a diagram showing an example of a synthesized image obtained by superposing a visible light image on a far-infrared light image. In FIG. 7, only the persons HM1 and HM2, and the red lamp of the traffic light signal SG are brightly displayed and other parts are dimmed; therefore it is possible for a driver to quickly and clearly discriminate objects to be noted.

FIG. 8 is a diagram showing an example of a synthesized image obtained by superposing a far-infrared light image on a visible light image. In FIG. 8, bright persons HM1 and HM2 are displayed so that they float up in a scene in the dim evening; therefore it is possible for a driver to quickly and clearly discriminate objects to be noted.

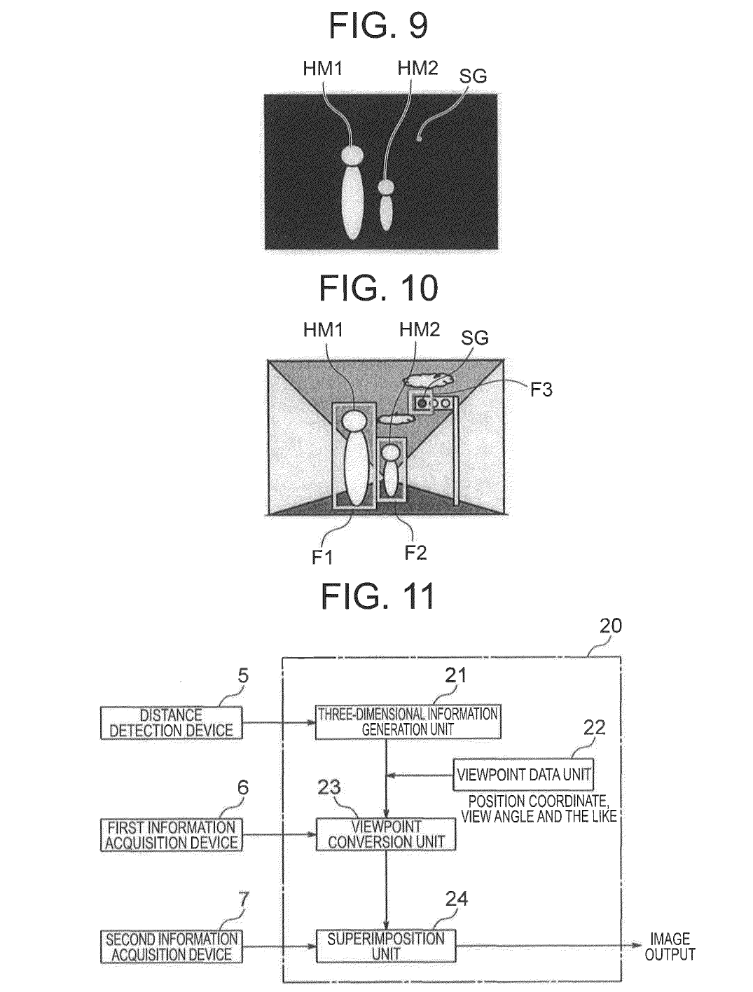

FIG. 9 is a diagram showing an example of a synthesized image obtained by superposing only an extract from a visible light image and an extract from a far-infrared light image on each other. In FIG. 9, the object recognition unit 13 extracts from the visible light image, for example, only the traffic light signal SG based on a color or shape of the object and extracts from the far-infrared light image only the persons HM1 and HM2 having a larger luminance value than a predetermined value because of generating heat and radiating a far-infrared ray, and the superimposition unit 15 embeds these extracts in a. black background to synthesize them for display; therefore it is possible for a driver to quickly and clearly discriminate objects to be noted.

FIG. 10 is a diagram, showing a synthesized image obtained by superposing a far-infrared light image on a visible light image and further adding a box to each object. In FIG. 10, the object recognition unit 13 extracts from the visible light image, for example, only the traffic light signal SG based on a color or shape of the object and extracts from the far-infrared image only the persons HM1 and HM2 having a larger luminance value than a predetermined value because of generating heat and radiating a far-infrared ray, and the data processing unit 14 adds frames (F1, F2 and F3) to the traffic light signal SG, persons HM1 and HM2, and after that, the superimposition unit 15 synthesizes them for display; therefore it is possible for a driver to quickly and clearly discriminate objects to be noted. In addition, objects to be extracted are not limited to the above things, and a vehicle, a sign or an obstacle may be extracted.

### Second Embodiment

FIG. 11 is a block diagram of an image synthesis device according a second Embodiment. In FIG. 11, a distance to the object is detected by using not the stereo camera system but a distinct distance detection device (the distance measurement means) 5. Moreover, an image synthesis section 20 has a three-dimensional information generation unit 21, a viewpoint data unit 22, a viewpoint conversion unit 23 and a superimposition unit 24.

More specifically, the three-dimensional information generation unit 21 detects an object distance on the basis of a signal from the distance detection device 5. The viewpoint conversion unit 23 inputs an image signal from a first information acquisition device (the first image acquisition means) 6 and converts the viewpoint position by referring to the relative position data of the preset first information acquisition device 6 and second information acquisition device 7, which is stored in the viewpoint data unit 22. The superimposition unit 24 inputs an image signal from the second information acquisition device 7 (the second image acquisition means) and synthesizes the inputted image signal so as to superpose on the image signal of the first information acquisition device, whose viewpoint position has been converted. The synthesized image signal is outputted from the image synthesis section 20 and displayed by the display device 4 (FIG. 2) or the like,

Herein, the distance detection means 5 may be what detects an object distance by projecting infrared light by a light cut-off method or TOF (Time of Flight). Moreover, the first information acquisition device 6 may be a visible light camera, an infrared light camera or the like. Furthermore, the second information acquisition, device 7 may be a far-infrared light camera, a milliwave radar, a laser radar or the like.

For example, the obstacle detection in a vehicle requires a process at the highest possible speed in order to cope with rushing out from a lateral direction. In general, a three-dimensional process has a large amount of data and a large processing load. Although there is a method in which both the visible light camera and the far-infrared light camera adopt a stereo system to generate and synthesize three-dimensional data, an increased processing load and a reduced frame rate bring a risk that detection ability would decline; therefore it is desirable to adopt a structure using a visible light stereo camera and a monocular infrared light, camera, as in the second embodiment.

Moreover, a near-infra red light camera may be used instead of the visible light camera, and a camera sensitive to visible light and near-infrared light may also be used.

In addition, the present invention is not limited, to the embodiments described in this specification, and it is clear for one skilled in the art from the embodiments described in this specification or the technical idea to include other embodiments or modification examples.

### INDUSTRIAL APPLICABILITY

The present invention is particularly effective, for example, to a vehicle-mounted camera, robot-mounted camera or the like, but its use is not limited to these cameras.

### Reference Signs List

1, 2 visible light camera

3 far-infrared light camera

4 display device

5 distance detection device

6 first information acquisition device

7 second information acquisition device

10 image synthesis section

11 three-dimensional information generation unit

12 viewpoint conversion unit

13 object recognition unit

14 data processing unit

15 superimposition unit

16 first movement detection unit

17 second movement detection unit

18 movement comparison unit

19 viewpoint data unit

20 image synthesis section

21 three-dimensional information generation unit

22 viewpoint data unit

23 viewpoint conversion unit

24 superimposition unit

VH vehicle

1. An image synthesis device, comprising:
first image acquisition means for acquiring object information using an electromagnetic wave in a first, wavelength, region to generate first image information concerning an object;
second image acquisition means for acquiring object, information using an electromagnetic wave in a second wavelength region from a viewpoint different from, that of the first image acquisition, means to generate second image information concerning the object, the second wavelength region being different from the first wavelength region;
distance measurement means for obtaining distance information to the object;
three-dimensional information generation means for generating three-dimensional information of the object on the basis of the distance information to the object; and
viewpoint conversion means for processing image information related to at least one of a first image and a second image on the basis of the generated three-dimensional information of the object so that photograph viewpoints in the first image based on the first image information and in the second image based on the second image information coincide with each other.

2. The image synthesis device as recited in claim 1, comprising superimposition means for superimposing the first image information and the second image information on each other so as to superpose the first image and the second image, which have been subjected to a viewpoint conversion process by the viewpoint conversion means.

3. The image synthesis device as recited in claim 1, comprising superimposition means for extracting specific information from the first image and the second image, which have been subjected to the viewpoint conversion process by the viewpoint conversion means, to superimpose the extracted specific information on each other.

4. The image synthesis device as recited in claim 2 or 3, wherein the superimposition means extracts object information having a luminance value equal to or larger than a predetermined value in the second image information to insert the extracted object information to the first image information.

5. The image synthesis device as recited in any one of claims 2 to 4, wherein the superimposition means extracts object information having a specific color or shape from the first image information to insert the extracted object information in to second image information.

6. The image synthesis device as recited in any one of claims 2 to 4, wherein the superimposition means extracts object information having a specific color or shape from the first image information and extracts object information having a luminance value equal to or larger than a predetermined value in the second image information to insert, the extracted object information to another background image information.

7. The image synthesis device as recited in any one of claims 4 to 6, wherein predetermined information is added to the extracted object information.

8. The image synthesis device as recited in any one of claims 1 to 7, wherein the distance measurement means obtains the distance information to the object on the basis of a plurality of parallax information obtained, from the first image acquisition means or the second image acquisition means, and the three-dimensional information generation means acquires the three-dimensional information of the object by applying the distance measurement information to the whole of an image plane.

9. The image synthesis device as recited in any one of claims 1 to 8, wherein the distance measurement means measures the distance to the object by projecting an electromagnetic wave to the object and measuring arrival time or a direction of a reflected electromagnetic wave, and the three-dimensional information generation means acquires the three-dimensional information of the object on the basis of the distance to the object.

10. The image synthesis device as recited in any one of claims 1 to 9, wherein the electromagnetic wave in the first wavelength region is visible light, or near-infrared light, or visible light and near-infrared light, and the electromagnetic wave in the second wavelength region is far-infrared light.
